(19) United States
(12) Patent Application Publication
(10) Pub. No.: US 2014/0360680 A1
(43) Pub. Date: Dec. 11, 2014

(54) BOOM SKIRT

(71) Applicant: Thomas Bürgin, Lorrach (DE)

(72) Inventor: Thomas Bürgin, Lorrach (DE)

(73) Assignee: MAGNETIC AUTOCONTROL GMBH, SHOPFHEIM (DE)

(21) Appl. No.: 14/370,654

(22) PCT Filed: Jan. 3, 2013
(86) PCT No.: PCT/DE2013/000009

§ 371 Date: Jul. 3, 2014

(30) Foreign Application Priority Data
Jan. 5, 2012 (DE) 20 2012 000 092.6
Jun. 9, 2012 (DE) 20 2012 005 703.0

(51) Int. Cl. E06B 11/02; B61L 29/04; E01F 13/06

(52) U.S. Cl. CPC E06B 11/02; E01F 13/06; B61L 29/04
USPC 160/160

(57) ABSTRACT

The invention relates to a barrier skirt (3,3′), e.g. for access barriers or railway barriers, which consists of a number of stanchions (4,4′) of identical shape which are suspended at mutual spacings between a barrier boom (2) hinged to a barrier housing (1) and swivable in the vertical plane and a rail (6,6′) running parallel to the barrier boom. The ends of the stanchions (4,4′) with which they are swivably connected to a guide rail (6,6′) running parallel to the barrier boom (2) or to a guide groove (5) on the barrier boom (2) are designed as cranked ends (13), thereby avoiding dangerous shearing and pinching points. The stanchions (4,4′) have a multi-part design and can be assembled from the individual parts and mounted without using a tool and can be replaced individually when required.

The invention relates to a barrier skirt comprising a number of identically shaped struts which are connected in a pivotable manner, and at a distance apart from one another, to a barrier boom, which is articulated on a barrier housing and can be pivoted in a vertical plane, and to a rail running parallel to the barrier boom.

DE 398707 discloses a barrier skirt of which the struts are set at their lower fastening end, and if required also at their upper fastening end, such that they can swing in automatically, without obstructing one another, when the barrier boom is raised vertically.

Barrier skirts should prevent any access beneath the barrier boom when the barrier is closed or should provide at least an additional safeguard for people, particularly for children, and also animals.

One problem with known barrier skirts is that during the operation of opening the barrier, when the barrier skirt folds together, there are pinch points and shear points virtually on each strut, that is to say a multiplicity of such pinch points and shear points overall, these constituting a risk of injury particularly for children wanting to reach for example into the barrier skirt. Such sources of risk, in accordance with the European Machinery Directive, have to be avoided.

It is frequently also considered to be necessary to equip a barrier not just with a means for preventing access beneath it, but, in addition, also with a barrier skirt forming a means for preventing access over it. In order to fasten the struts of a means for preventing access over the barrier, it is known for the struts to be drilled and fastened on the barrier boom by screws. Since the struts are usually made of metal, preferably aluminum, additional sliding rails have to be fitted on the barrier boom in order to prevent scratching of the struts and of the barrier boom.

It is an object of the invention to provide a reliable barrier skirt in the case of which there are no pinch points and shear points, in particular during the operation of opening the barrier. The barrier skirt, moreover, should be straightforward to assemble, and, following any possible damage to the struts, easy to repair; it should be possible for the struts to be easily changed over or replaced. It should be possible for the novel barrier skirt to be used both as a means for preventing access beneath it and also, if required, as a combined means for preventing access beneath it and over it.

This object is achieved according to the invention by a barrier skirt as claimed in claim 1.

According to the invention, that end of the struts by way of which they are connected in a pivotable manner to a guide rail running parallel to the barrier boom, or to a guide groove on the barrier boom, is designed in the form of an angled end. The angled ends of the struts avoid shear points on the guide rail running at a distance from, and parallel to, the barrier boom.

According to a first embodiment of the invention, which can be used particularly advantageously for a barrier skirt as a means for preventing access beneath the barrier, the upper and lower ends of the struts are angled in opposite directions, and the upper end is connected in a pivotable manner to a guide groove on the barrier boom and the lower end is connected in a pivotable manner to a guide rail running at a distance beneath, and parallel to, the barrier boom. The angling at the two ends of the struts means that, during the opening movement of the barrier and in the open state of the barrier, there are no pinch points or shear points between the ends of the struts and the guide groove on the barrier boom, or the guide rail running parallel to the barrier boom, and a risk of injury is therefore ruled out as far as possible.

According to another embodiment of the invention, it is likewise the case that the two ends of the struts are angled; the one angled end of the struts is connected in a pivotable manner to a guide rail running at a distance beneath, and parallel to, the barrier boom and the other angled end of the struts is connected in a pivotable manner to a guide rail running at a distance above, and parallel to, the barrier boom, and each strut is connected in a pivotable manner to the barrier boom at a point between, and at a distance from, the two angled ends of the struts. This embodiment of the struts is suitable particularly for barriers which are to be equipped both with a means for preventing access beneath them and with a means for preventing access over them.

According to a more straightforward embodiment of the barrier skirt with a means for preventing access beneath the barrier and over the same, it is possible for just the one end of the struts to be angled and said angled end may be connected in a pivotable manner to a guide rail running at a distance beneath, and parallel to, the barrier boom, whereas the other end of the struts can project freely upward from the barrier boom; each of the struts here is connected in a pivotable manner to the barrier boom at a point between, and at a distance from, the strut ends.

It is advantageously possible for each angle end of the struts to have formed on it a foot part, by way of which each strut can be fitted in a pivotable manner in a guide rail running parallel to the barrier boom, or in a guide groove on the barrier boom.

In order to position the struts in the guide groove and the barrier boom, or in the guide rail or rails, and to keep them in position, it is possible for spacer strips to be introduced, between the angled ends of the struts, into the guide groove on the barrier boom, or into the guide rails. By virtue of the length of the spacer strips being selected correspondingly, the distance between the struts can be altered as required. In order to prevent small animals from being able to pass between the struts, or for using the barrier skirt in respect of game, the distance between the struts is selected to be rather narrow; with other applications, a rather wide distance between the struts may be advantageous.

The spacers strips are preferably retained in the guide rails, or in the guide groove, by engagement means and have apertures, with which a foot part formed at the angled end of a strut can be brought into engagement.

The spacer strips may be of U-shaped design and retained in the guide rails by inwardly curved side walls of the guide rails; in their side walls, the spacer strips may have apertures, with which the foot part formed at the angled end of a strut can be brought into engagement. This makes it possible for the barrier skirt to be fitted out in a very straightforward manner.

The foot part of the angled ends of the struts is formed on preferably transversely and has connecting stubs which are directly transversely to the angled end, and counter to one another, and can be brought into engagement with the apertures of a spacer strip. Once the required number of spacer strips has been pushed into the guide rail, the struts can be inserted very straightforwardly one after the other into the spacer strips. The connecting stubs of the foot part here, in the first instance, are still retained in the direction of the guide rail, or of the spacer strips, and can be anchored in the apertures of a spacer strip, and thus in the guide rail, by being rotated through 90°.

If a connecting rod has its one end connected in an articulated manner, at a first point of rotation, to that end of a guide rail running at a distance beneath, and parallel to, the barrier boom which is directed towards the barrier housing and has its other end connected in an articulated manner, at a further point of rotation, to the barrier housing via a spacer, the barrier skirt is more stable and it is also the case, during quick opening and closing movements of the barrier, that a disruptive pendulum swinging motion of the barrier skirt is prevented. Appropriate selection of the height H of the point of rotation of the connecting rod on the barrier housing and/or of the length L of the connecting rod can achieve the situation where, even with the barrier open, the struts are not located directly one upon the other; rather, a defined distance remains between them, and this therefore avoids pinch points between the struts. The connecting rod, moreover, prevents the situation where the barrier skirt, with the barrier closed, can be folded manually and can thus create an inadmissible through-passage at the barrier boom.

According to one embodiment of the invention, each strut preferably comprises three individual parts, that is to say two end pieces and a central piece; the end pieces here are angled at their one end and are of rectilinear design at their other end, and two end pieces have their rectilinear end connected to a respective end of the central piece, which is rectilinear throughout.

According to a second embodiment, each strut comprises five individual parts, that is to say two end pieces with an angled end and a rectilinear end, two central pieces, which are rectilinear throughout, and a connecting piece; each end piece has its rectilinear end, which is directed away from the angled end, connected to one end of a central piece, which is rectilinear throughout, and the other end of each central piece, which is rectilinear throughout, is connected to a connecting piece, which is articulated on the barrier boom. This embodiment of a strut makes it possible, in an advantageous and straightforward manner, to put together barrier skirts with both a means for preventing access beneath the barrier and a means for preventing access over the same.

For this purpose, the connecting piece is preferably arranged laterally on the barrier boom such that it can be pivoted about a pin, and it has two oppositely directed extensions, to which in each case one end of the central pieces of a strut of the second embodiment is connected.

If the pin about which the connecting piece can be pivoted on the barrier boom is designed such that there is a distance between the barrier boom and the connecting piece, this avoids scratching on the barrier boom or on the connecting piece.

It is preferable, in accordance with the first, three-part embodiment of the struts, for the end pieces to be of rod-like design and for the central pieces to be of tubular design, and the end pieces may advantageously have their rectilinear, rod-like end, which is directed away from the angled end, connected to a respective end of a tubular central piece by a snap-fit connection. It is thus possible for the struts to be joined together very straightforwardly and quickly, without the aid of a tool, from the end pieces and central pieces and also to be fitted, by way of the foot part of their angled ends, into a guide groove on the barrier boom, and into a guide rail running parallel to the barrier boom. Should any individual struts be damaged at all, then these can be straightforwardly changed over and replaced. The snap-fit connections of a damaged strut between the end pieces and the central piece are released, whereupon the end pieces once again without the aid of a tool, can be released from the guide groove on the barrier boom, or from the guide rail, and a new strut can be installed in reverse order.

As an alternative, it is possible for the end pieces of the struts to be of tubular design and for the central pieces to be of rod-like design, wherein, once again, the end pieces have their rectilinear end, which is directed away from the angled end, connected to a respective end of a central piece by a snap-fit connection.

In accordance with the second, five-part embodiment of the struts, it is preferably the case that the two end pieces and the oppositely directed extensions of the connecting piece are of rod-like design and the two central pieces of a strut are of tubular design, and the end pieces have their rectilinear end, which is directed away from the angled end, connected to the one end of a central piece, and the other end of each central piece is connected to in each case one of the extensions of a connecting piece, by a snap-fit connection. It is also the case that this embodiment of the struts can be assembled quickly, without the aid of a tool, from its individual parts and installed on the barrier boom, and on the guide rails, to form a barrier with a means for preventing access beneath it and over it. Individual damaged struts can be changed over quickly and straightforwardly for new struts.

As an alternative, it is possible for the two end pieces and the oppositely directed extensions of the connecting piece to be of tubular design and for the two central pieces of a strut to be of rod-like design and for the end pieces to have their rectilinear end, which is directed away from the angled end, connected to the one end of a central piece by a snap-fit connection, whereas the other end of each central piece may be connected to in each case one of the tubular extensions of a connecting piece likewise by a snap-fit connection.

The snap-fit connections on a strut may be formed by at least one resiliently compliant complexity with an outwardly oriented, stub-like protrusion being provided on each end piece at the rectilinear end, which is directed away from the angled end and is to be connected to a central piece, and by the two ends of each central piece each having at least one lateral engagement hole for the stub-like protrusion of the convexity at the rectilinear end of an end piece, and by it being possible to push the ends of a central piece over a respective end of an end piece which has the convexity with stub-like protrusion until the stub-like protrusion latches into an engagement hole on the central piece. Such a snap-fit connection allows the struts to be joined together without the aid of a tool. In order to release the snap-fit connections, all that is required is to have a very straightforward tool, comparable to pincers, with which the stub-like protrusion of an end piece can be pushed out of the engagement hole of the central piece, and therefore the relevant strut can be dismantled.

Of course, it is also possible for the snap-fit connections to be formed in an equivalent manner by the convexity with stub-like protrusion being at the ends of each central piece and the engagement hole for the stub-like protrusion being at the rectilinear end of each end piece.

In accordance with the second embodiment of the struts, at least one resiliently compliant convexity with an outwardly oriented, stub-like protrusion is provided at the rectilinear end, which is directed away from the angled end, of the two end pieces and on the rectilinear extensions of the connecting piece of a strut, and the two ends of each central piece each have at least one lateral engagement hole for the stub-like protrusion of one of the convexities; the ends of a central piece are each pushed over that end of the end pieces, and of the extensions of a connecting piece, which has the convexity with stub-like protrusion until the stub-like protrusion latches into an engagement hole on the central piece.

The aforementioned equivalent design of the snap-fit connection is also possible in the case of this embodiment.

The diameter of the rectilinear, rod-like end pieces and of the rod-like extensions of the connecting piece at the resiliently compliant convexity in the non-stressed state of said convexity is advantageously larger than the open diameter of a central piece. In the assembled state of a strut, the convexity is then prestressed and there is a play-free connection between end pieces, central pieces and the connecting piece.

The snap-fit connections can be rendered more secure by the rectilinear, rod-like end of the end pieces and the rectilinear extensions of the connecting piece, which are to be connected to a central piece, being designed with two mutually opposite, resiliently compliant convexities, each with a stub-like protrusion, and by the two ends of the rectilinear central pieces having two mutually opposite engagement holes for the stub-like protrusions on the end pieces and on the extensions of a connecting piece. Here too, the aforementioned equivalent solution is possible.

In the case of a barrier with the means for preventing access beneath it and over it, a row of connecting pieces may be arranged laterally on the barrier boom. Each connecting piece here can be pivoted about a pin at a distance from the barrier boom and has oppositely directed extensions, to which the central pieces of a strut are connected; the connecting pieces on the barrier boom here are spaced apart in accordance with the desired distance between the struts.

All the individual parts of the struts, that is to say the end pieces, the central pieces and the connecting pieces, may consist of a plastics material, or it is possible for the end pieces and the connecting pieces to consist of a plastics material and for the central pieces to consist of aluminum. A barrier skirt thus has smooth-running properties, is lightweight and moves without any significant development of noise.

If the end pieces and the connecting pieces of the struts consist of a plastics material and the central pieces of the struts consist of stainless steel, the struts are particularly resistant to weathering.

In order to avoid damage or injury, it is possible for at least the guide rail running at a distance beneath, and parallel to, the barrier boom to have an edge guard, drawn over its entire length.

The edge guard may have a bead-like profile on which are provided recesses, with which engagement means provided on the guide rail can be brought into engagement.

A further advantage of the barrier skirt according to the invention is that its individual parts—such as struts, end pieces, central pieces and connecting pieces of the struts, guide rails, spacer strips and connecting rod together with spacer—can be packed in a very compact manner for transportation and assembly on site; this cuts back on the amount of space required for transportation and reduces transporting costs, also on account of the reduced weight; assembly on site is, as described, very straightforward.

The invention will be described in more detail hereinbelow with reference to the accompanying drawings, in which:

FIG. 1 shows the view of a barrier with a barrier skirt according to a first embodiment of the invention, the barrier being in the closed state,

FIG. 2 shows the view of the barrier with barrier skirt according to FIG. 1, the barrier being in the half-open state,

FIG. 3 shows the view of the barrier with barrier skirt according to FIG. 1 or 2, the barrier being in the open state,

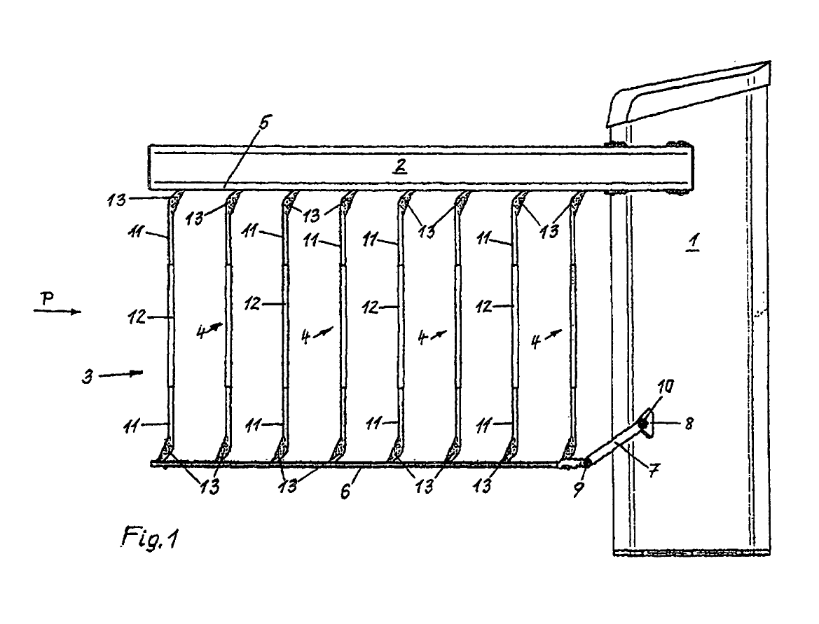

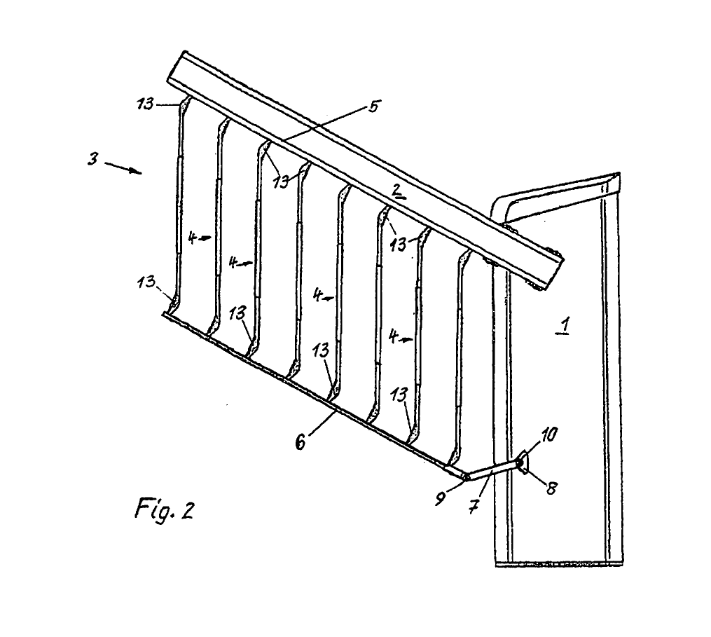

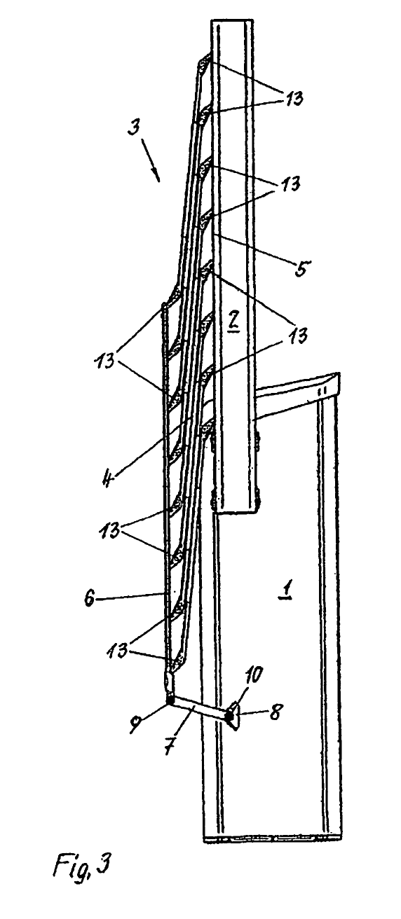

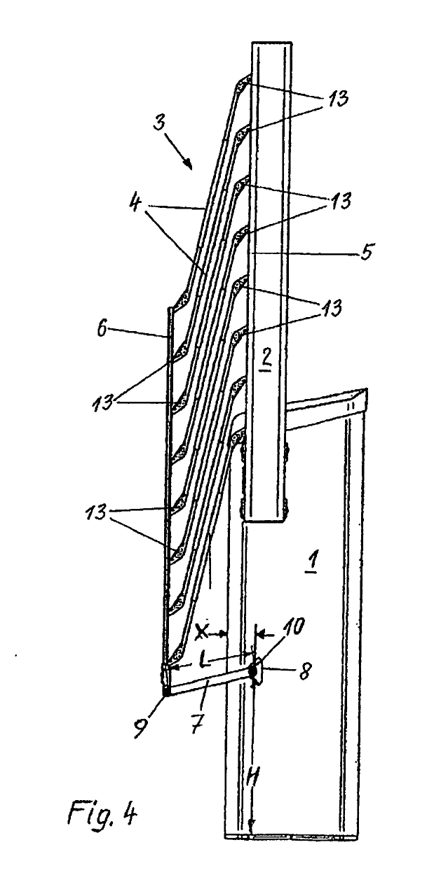

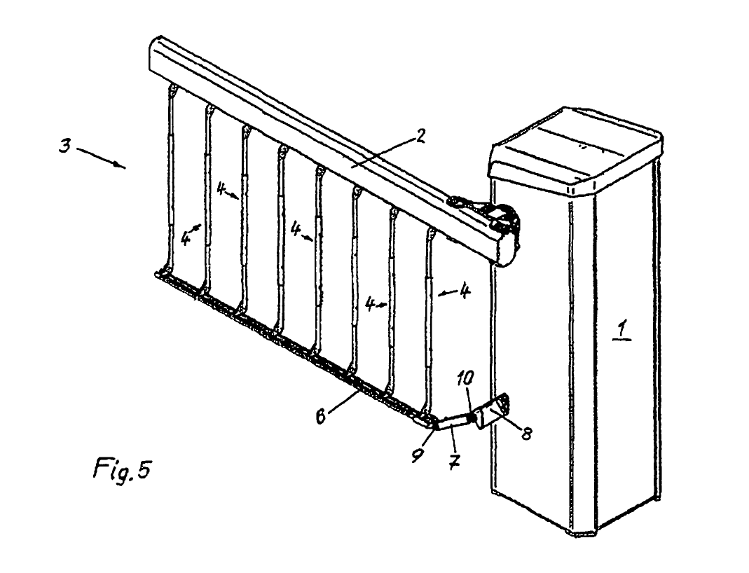

FIG. 4 shows the view of a barrier with a barrier skirt according to another embodiment of the invention, the barrier being in the open state,

FIG. 5 shows a perspective view of the barrier according to FIG. 1,

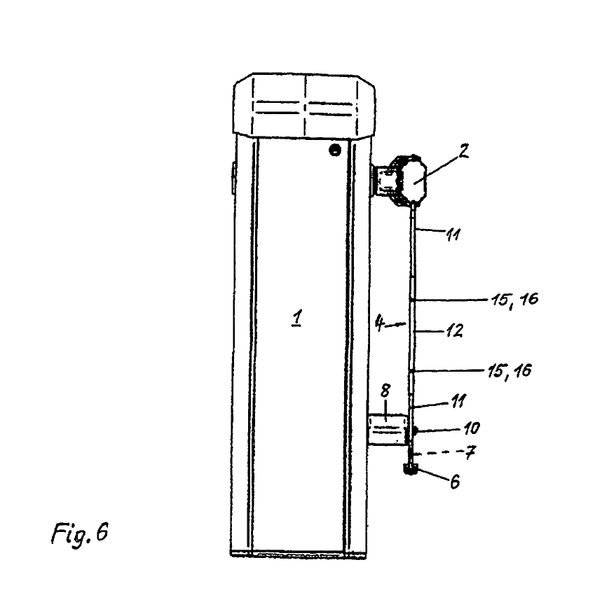

FIG. 6 shows the view of the barrier according to FIG. 1 as seen in the direction of the arrow P in FIG. 1,

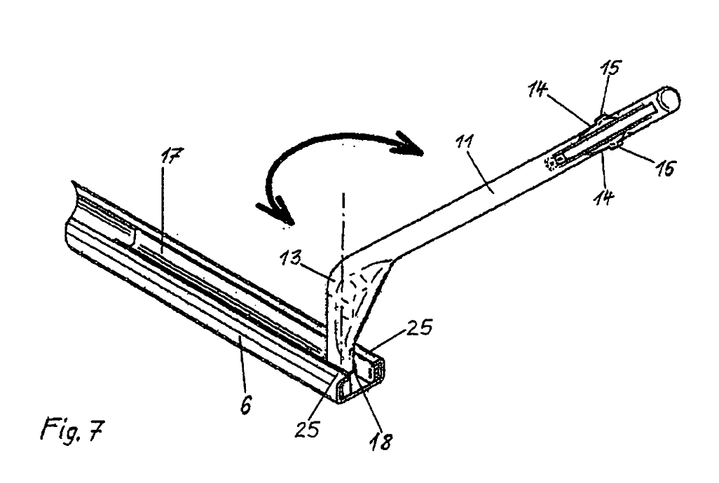

FIG. 7 shows a detail of a strut according to the invention during the operation of fastening the same on a guide rail,

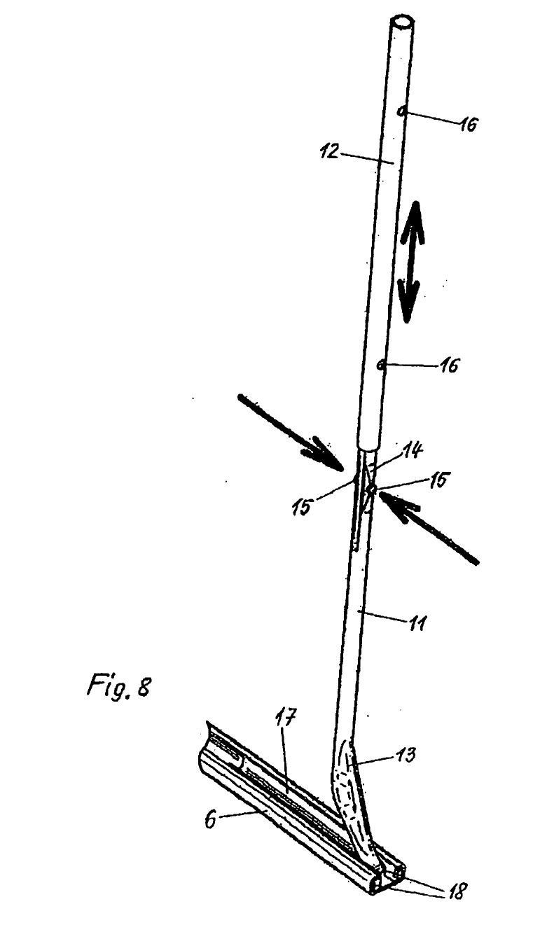

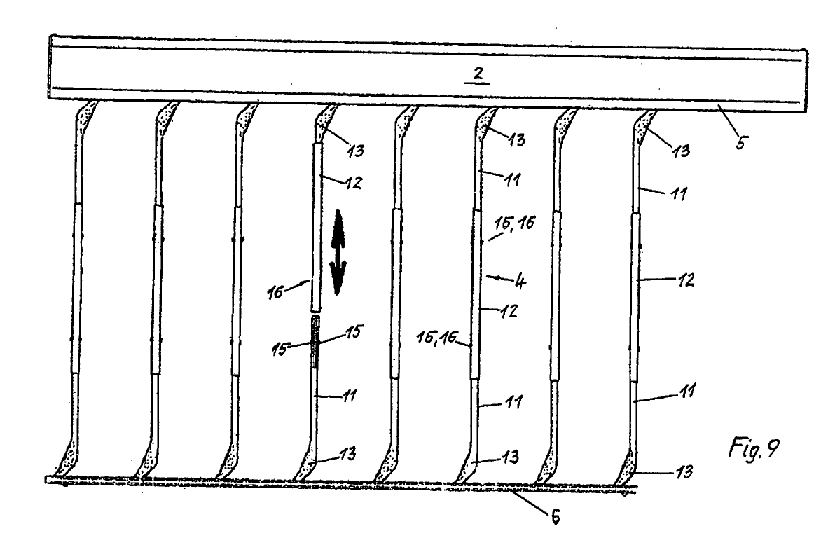

FIG. 8 shows individual parts of a strut according to the invention during the operation of assembling the same,

FIG. 9 shows a view just of a barrier boom with a barrier skirt according to the invention during the operation of changing over an individual strut,

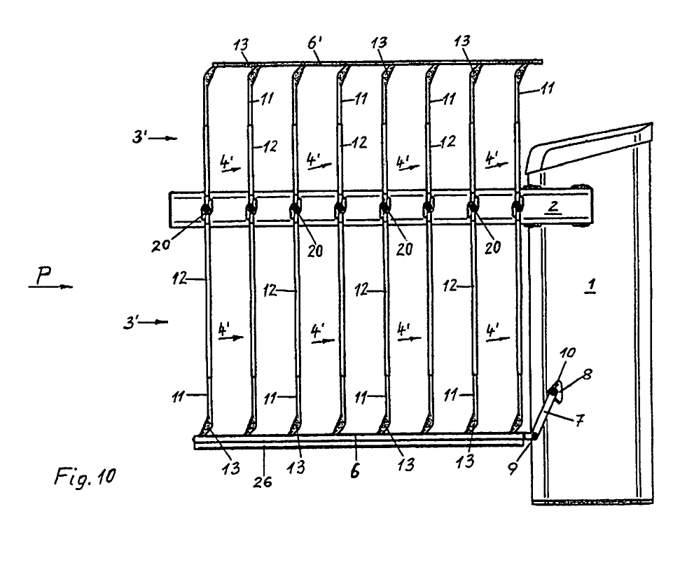

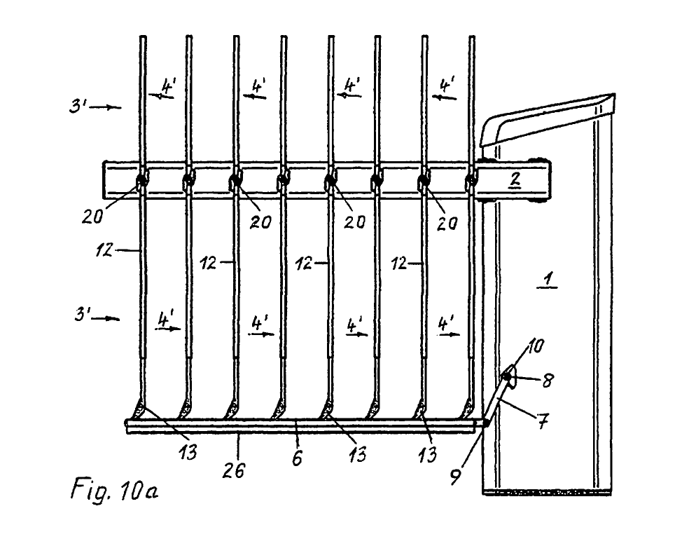

FIG. 10 shows the view of a barrier in the closed state with a barrier skirt according to a further embodiment of the invention providing both a means for preventing access beneath the barrier and a means for preventing access over the same,

FIG. 10a shows a simplified form of the embodiment according to FIG. 10.

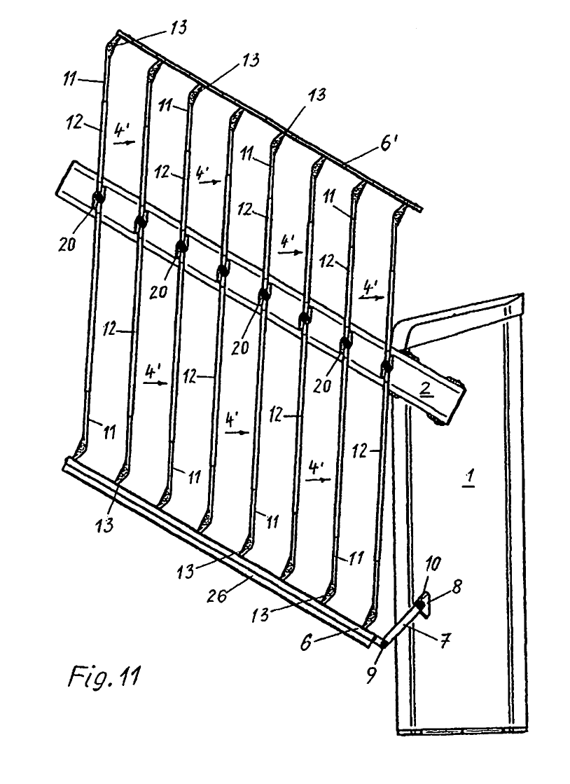

FIG. 11 shows the view of the barrier according to FIG. 10 in the half-open state,

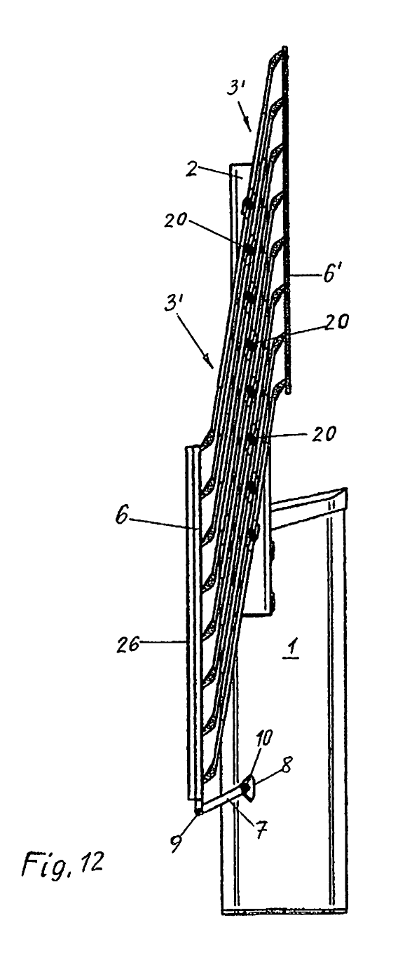

FIG. 12 shows the view of the barrier according to FIGS. 10 and 11 in the open state,

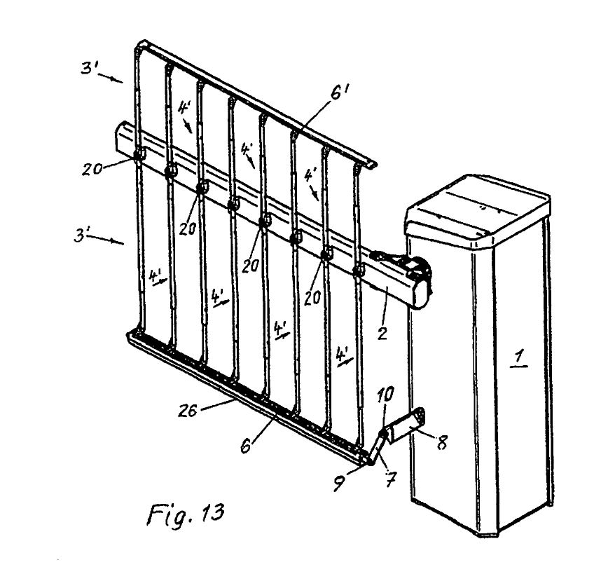

FIG. 13 shows a perspective view of the barrier according to FIG. 10,

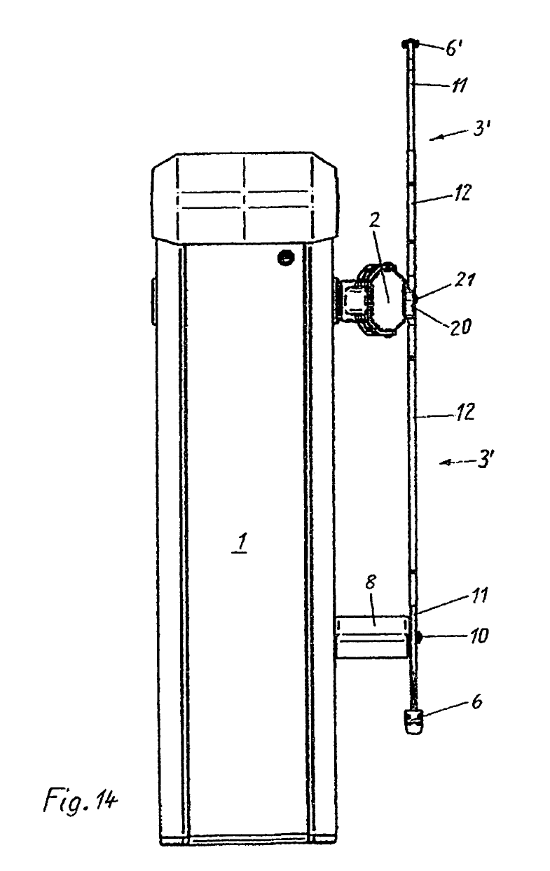

FIG. 14 shows the view of the barrier according to FIG. 10 as seen in the direction of the arrow P in FIG. 10.

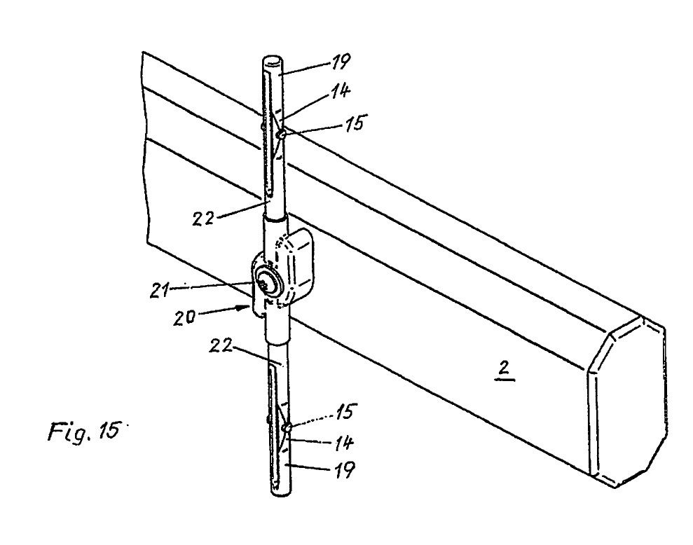

FIG. 15 shows a perspective view, as an enlarged detail from FIG. 13, of an individual part of a strut according to the invention used in FIG. 13,

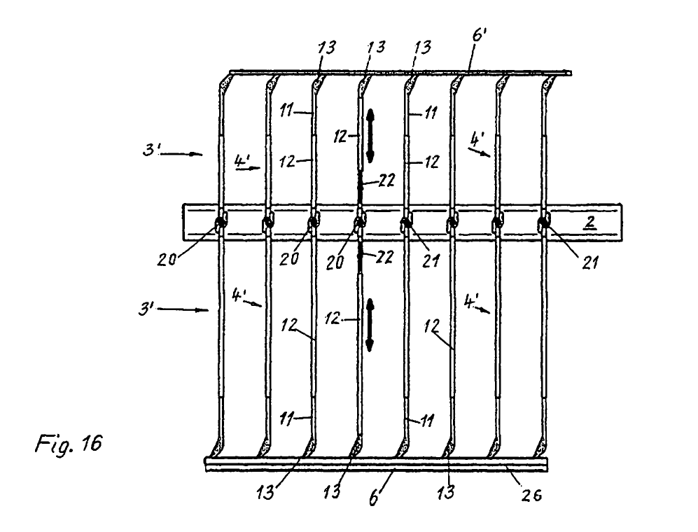

FIG. 16 shows a view (just) of a barrier boom with a means for preventing access beneath the barrier and over the same according to FIG. 10 during the operation of changing over individual struts,

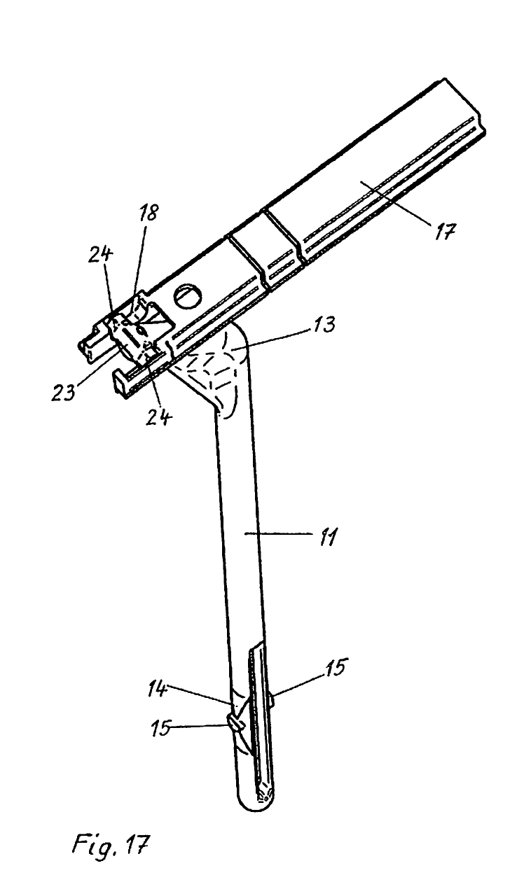

FIG. 17 shows, by way of example, the connection of a strut by way of its angled end, in a spacer strip or a guide rail, and

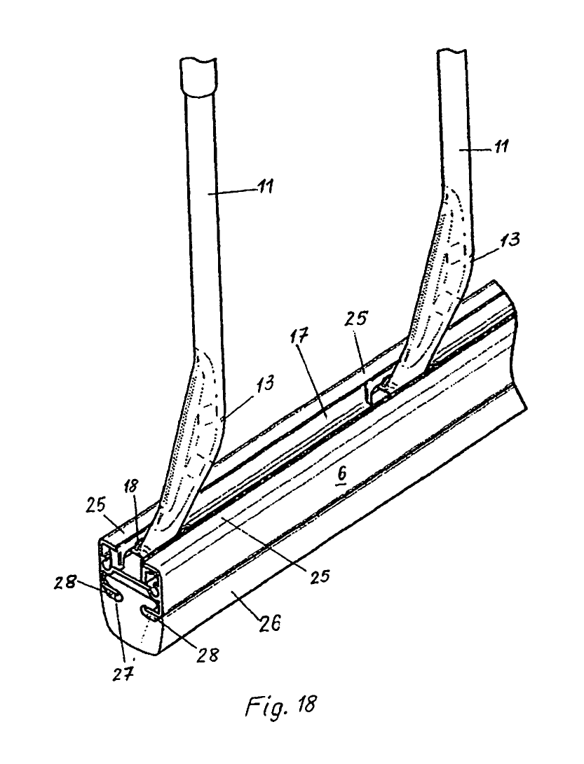

FIG. 18 shows, by way of example, an edge guard for guide rails on a barrier skirt according to the invention.

FIG. 1 shows the view of a barrier with a barrier skirt 3 according to a first embodiment of the invention as a means for preventing access beneath the barrier, to be precise in the closed state of the barrier. A barrier boom 2 is articulated in a pivotable manner on a barrier housing 1. A barrier skirt 3 comprises struts 4 which are retained at a distance apart from one another, and such that they can be pivoted in the plane of the barrier skirt 3, with their upper ends in a guide groove 5 on the barrier boom 2 and their lower ends in a guide rail 6 running at a distance beneath, and parallel to, the barrier boom 2. The upper and lower ends 13 of the struts 4 are angled, according to the invention, in opposite directions. As a result, during the opening movement of the barrier, and also in the open state of the barrier, there are no pinch points and shear points (see FIGS. 2 and 3 and 4), between the ends 13 of the struts 4 and the guide groove 5 on the barrier boom 2, or the guide rail 6, and there is therefore no risk of injury arising from such points. A connecting rod 7 articulated at that end of the guide rail 6 which is directed toward the barrier housing 1 and also a spacer 8 connect said end of the guide rail 6, likewise in an articulated manner, to the barrier housing 1. Said connecting rod 7, during the opening and closing movements of the barrier, executes a pivoting movement about a point of rotation 9 on the guide rail 6 and a point of rotation 10 on the spacer 8 of the barrier housing 1 (see also FIGS. 2 and 3); it guides the barrier skirt 3 or the struts 4 in the process and prevents a pendulum swinging motion of the barrier skirt 3 when the barrier moves quickly; the barrier skirt 3 is rendered transversely stable (see also FIG. 6). Moreover, said connecting rod 7 prevents the situation where the barrier skirt 3, with the barrier closed, can be folded manually to allow inaccessible through-passage beneath the barrier boom 2. By virtue of the height H and the horizontal position X of the spacer 8 on the barrier housing 1 and thus the position of the point of rotation 10 on the barrier housing 1 and/or the length L of the connecting rod 7 being selected accordingly, it is possible to achieve the situation where, even with the barrier open, the struts 4 are not located directly one upon the other; rather, a defined distance remains, this therefore avoiding possible pinch points even between the struts 4 themselves (see FIG. 4).

According to this embodiment of the invention, each strut 4 comprises three individual parts, that is to say two end pieces 11 and a central piece 12, which, assembled together, form a strut 4. FIG. 7 shows an end piece 11 of a strut 4 during the operation of introducing the same into the guide rail 6, or into a spacer strip 17 introduced beforehand into the guide rail 6 (see, in this respect, also FIG. 17 below). Each end piece 11 comprises a rod-like part, preferably made of plastics material, which is angled, that is to say forms an angle, at its one end 13; the angle here may be filled with material for reinforcing purposes, as can be seen in the figures. The other end of each end piece 11 is of rectilinear design. An end piece 11 can be introduced, with the aid of a foot part 23 formed at its angled end 13 (see also FIG. 17), into the guide rail 6, or correspondingly into the guide groove 5 on the barrier boom 2, and anchored therein in a pivotable manner by rotation (see FIG. 7), parts of the foot part 23 engaging in the guide rail 6 or guide groove 5 (see FIG. 17). The central piece 12 of each strut 4 is of tubular and rectilinear design throughout and preferably consists of aluminum, although stainless steel may also be selected. At its two ends, it can be connected, by a snap-fit connection, to in each case the rectilinear end of an end piece 11 to from a strut (see, in this respect, also FIG. 8). For this purpose, the rectilinear end region of each end piece 11, said end region being directed away from the angled end 13, has preferably two mutually opposite, resiliently compliant convexities 14 each with a stub-like protrusion 15 and, correspondingly, mutually opposite engagement holes 16 are provided in the two end regions of each central piece 12, which is rectilinear throughout. The open diameter of each central piece 12 is larger than the diameter of the rectilinear end of the end pieces 11 by such an extent that a central piece 12 can have its ends pushed over the rectilinear end of a respective end piece 11, and the resiliently compliant convexities 14 thereof, until the stub-like protrusions 15 on the convexities 14 snap into the engagement holes 16 on the central piece 12. It is advantageously possible for the diameter of each end piece 11 on the resiliently compliant convexities 14 in the non-stressed state of said convexities 14 to be larger than the open diameter of the central piece 12 to such an extent that, in the assembled state of a strut 4, the convexities 14 are stressed and there is a play-free connection between the end piece 11 and central piece 12.

In a quite equivalent manner, it is also possible for the snap-fit connections to be produced by the convexities with the stub-like protrusions being provided at the ends of the central pieces of the struts and the engagement holes for the stub-like protrusions being provided at the rectilinear ends of the end pieces.

It is thus possible for a strut 4 to be joined together very straightforwardly, without the aid of any tool, from two end pieces 11 and a central piece 12 and to be introduced by way of the angled ends 13 of the end pieces 11, said ends forming the upper and lower ends of the strut 4, likewise straightforwardly, without the aid of a tool, into the guide groove 5 on the barrier boom 2 and into the guide rail 6 (see FIG. 7 together with FIG. 1). The struts 4 can be placed, and retained, at a desired distance apart from one another (see FIGS. 8 and 17 together with FIG. 1) with the aid of spacer strips 17 which are introduced, between the angled ends 13 of the struts 4, or the end pieces 11 thereof, into the guide groove 5 on the barrier boom 2 and the guide rail 6. It is possible here for the distance between the struts 4 to be selected differently as required with the aid of spacer strips 17 of different lengths; the distance between the struts 4 may be selected to be, for example, rather small, in order to prevent small animals, e.g. small dogs or cats, from passing through the barrier skirt 3. It is also the case when the barrier skirt is being used in respect of game that the distance between the struts 4 will be selected to be rather small. In other application cases, a rather wide distance between the struts 4 may be advantageous. As already mentioned, it is possible for the angled ends 13 of the end pieces 11 to be inserted, by way of a foot part 23 formed thereon, in the first instance in a transversely directed manner into the guide groove 5 on the barrier boom 2, and the guide rail 6, and to be retained therein by being rotated through 90°, the foot part 23 being brought into engagement here with engagement means, e.g. with U-shaped engagement grooves, formed on the guide groove 5 or the guide rail 6.

According to a preferred embodiment as in FIGS. 8 and 17, the spacer strips 17, which determine the distance between the struts 4, are U-shaped and, in their side walls, have apertures 18 (see also FIG. 7), with which the foot part 23 of an end piece 11 can be brought into engagement. As can be seen more clearly from FIG. 17, the foot part 23, which is formed at the angled end 13 of each end piece 11, has two connecting stubs 24 projecting in opposite directions and transversely to the angled end 13. It is advantageously possible according to the invention in the first instance for the number of spacer strips 17 which is required for the barrier skirt 3 to be pushed one after the other into the guide rail 6, or into the guide groove 5 on the barrier boom 2, wherein they are retained by side walls 25 of the guide rail 6 or guide groove 5 (see FIG. 18), said side walls being oriented in a U-shaped manner. This defines the distance between the struts 4. It is then possible for the end pieces 11 to be inserted one after the other by way of their foot part 23, in the first instance with the connecting stubs 24 oriented in the direction of the guide rail 6 or guide groove 5, into the apertures 18 of the spacer strips 17 already located in the guide rail 6, or the guide groove 5, and to be brought into engagement in the apertures 18 by rotation through 90°.

The struts 4 are locked reliably, following assembly, if, in the first instance, the two end pieces 11 of a strut 4 are inserted into the guide groove 5 on the barrier boom 2 and the parallel guide rail 6, or into the spacer strips 17 already positioned therein, followed by the rotations through 90° at the guide groove 5 and at the guide rail 6, or in the spacer strips 17, in opposite directions and, thereafter, the central piece 12 is connected to the two end pieces 11 by means of the abovedescribed snap-fit connections. The angled ends 13 at the guide groove 5 of the barrier boom 2 and at the guide rail 6 should, as illustrated (see FIG. 1), be oriented in respectively opposite directions following assembly.

The possibility of a barrier skirt also being damaged from time to time cannot be ruled out. Laborious work with the aid of tools is required in order to eliminate the damage from known barrier skirts. On the barrier skirt 3 according to the invention, the three-part construction of the struts 4 according to the invention means that one or even more of the latter, when damaged, can be dismantled and replaced anew in an extremely straightforward manner. FIG. 9 illustrates, by way of example, the operation of changing over an individual strut 4. With the aid of a very straightforward tool, similar to pincers, the stub-like protrusions 15 on the end pieces 11 are pushed inwards out of the engagement holes 16 on the central piece 12 of the relevant strut 4. Thereafter, the central piece 12 can be pushed to a further extent over the one end piece 11 until it frees the other end piece 11. It is then possible for the two end pieces 11 to be released from the guide groove 5 on the barrier boom 2, and from the guide rail 6, at their angled ends 13, the central piece 12 being carried along in the process, and for a new strut 4 comprising two end pieces 11 and a central piece 12 to be installed in reverse order.

As already mentioned, there is also a need for barriers which, in addition to a means for preventing access beneath them, are equipped with a means for preventing access over them. FIGS. 10 to 16 show a barrier which meets this requirement. FIG. 10 shows the view of a barrier in the closed state with a barrier skirt 3′ according to a second embodiment of the invention providing both a means for preventing access beneath the barrier and a means for preventing access over the same. Hereto, a barrier boom 2 is articulated in a known manner such that it can be pivoted on a barrier housing 1. The barrier skirt 3′ comprises the struts 4′ each of which, according to this embodiment, comprise five individual parts, that is to say two end pieces 11, two central pieces 12 and a connection piece 20. The end pieces 11 and the central pieces 12 are designed in the same manner as described above in conjunction with the first embodiment of the invention. FIG. 15 shows a preferred embodiment of a connecting piece 20 according to the invention. Each connecting piece 20, according thereto, has two oppositely directed, rod-like extensions 22, of which the free end portions 19 are provided with parts of a snap-fit connection, as is also the case with the abovedescribed end pieces 11 at their rectilinear end, to be precise two mutually opposite, resiliently compliant convexities 14 each with a stub-like protrusion 15 are formed on the free end portions 19. Engagement holes 16 are provided in the two end regions of each of the tubular central pieces 12. It is possible for a strut 4′ according to this embodiment to be joined together, once again, very straightforwardly and without the aid of a tool, by the one end of a respective central piece 12 being connected to the two rod-like extensions 22 of a connecting piece 20, and the other end of these two central pieces 12 being connected to the rectilinear end of a respective end piece 11, by means of the snap-fit connections described.

In order for a barrier skirt 3′ with a means for preventing access beneath the barrier and above the same to be installed on a barrier boom 2, the required number of connecting pieces 20 are arranged, preferably laterally on the barrier boom 2, in a row and at a distance apart from one another which is also to be maintained by the struts 4′. Each of the connecting pieces 20 is arranged laterally on the barrier boom 2 such that it can be pivoted about a pin 21 preferably at its center (see, in this respect, also FIGS. 10 to 13). Said pivot pins 21 here are advantageously formed such that the struts 4′ are retained at a distance from the barrier boom 2, in order to prevent scratching of the barrier boom 2 or of the struts 4′. With the barrier closed (see FIG. 10), the extensions 22 of the connecting pieces 20 on the barrier boom 2 are oriented vertically upward and downward. With the aid of the snap-fit connections described, a respective central piece 12 has its one end connected to the ends of the extensions 22 of the connecting pieces 20 (see also FIG. 15); the rectilinear end of a respective end piece 11 is connected, likewise by means of a snap-fit connection, to the other end of each central piece 12. This results in struts 4′ which, with the barrier closed, extend vertically upward and vertically downward from the barrier boom 2, or from the respective connecting piece 20, and each terminates with the angled ends 13 of their end pieces 11, this therefore resulting, in the downward direction, in a means for preventing access beneath the barrier and, in the upward direction, in a means for preventing access over the same. In order for the barrier skirt 3′ with a means for preventing access beneath the barrier and over the same to be produced, the struts 4′ have their downwardly oriented angled ends 13 of their one end pieces 11 fitted in the manner described above, with the aid of a foot part 23 formed at the angled end 13 and with the aid of spacer strips 17 (see FIG. 17), into a first guide rail 6, running beneath, and parallel to, the barrier boom 2; the struts 4′ have their upwardly oriented angled ends 13 and their other end pieces 11 fitted, in the same way, into a second guide rail 6′, running above, and parallel to, the barrier boom 2; this results in a barrier skirt 3′ with a downwardly directed means for preventing access beneath the barrier and with an upwardly directed means for preventing access over the same. For assembly purposes, the required number of spacer strips 17 are pushed into the two guide rails 6 and 6′ and then the one end pieces 11 of the struts 4′ are fitted one after the other into the apertures 18 of the spacer strips 17 on the one (lower) guide rail 6 and the other end pieces 11 of the struts 4′ are fitted into the apertures 18 of the spacer strips 17 on the other (upper) guide rail 6′. As already described above, for this purpose, the end pieces 11 have the foot part 23 formed on them inserted into the apertures 18 of the spacer strips 17, wherein the connecting stubs 24 formed on the foot part 23 in the first instance are oriented in the direction of the guide rail 6 or 6′; thereafter, each end piece 11 is rotated through 90° in the relevant aperture 18 and thus anchored in the guide rail 6, 6′, or the relevant spacer strip 17, such that it can be pivoted in the direction of the resulting barrier skirt 3, 3′. It is also the case with this embodiment of the invention that the angled ends 13 of each strut 4′ at the two guide rails 6, 6′ should be oriented preferably in the opposite directions.

It is also the case with this embodiment of the struts that the snap-fit connections may be configured in the equivalent manner described above.

FIG. 10a shows a simplified embodiment of a barrier skirt with a means for preventing access beneath the barrier and over the same. It differs from the embodiment according to FIG. 10 in that the guide rail 6′ of the means for preventing access over the barrier, i.e. the guide rail 6′ above the barrier boom 2, has been dispensed with. It is also possible here to do away with those end pieces 11 of the struts 4′ which belong to the means for preventing access over the barrier according to FIG. 10.

It is advantageous if an edge guard 26 is provided at least on the guide rail 6 running beneath the barrier boom 2 or else on both guide rails 6, 6′. According to FIG. 18, it is possible, for this purpose, for the side walls of the relevant guide rails 6 to be extended downward, i.e. to be directed away from the angled ends 13 of the struts 4, 4′, and to be angled inwards in an L-shaped manner. A bead-like edge guard 26 consisting of a suitable plastic material or of rubber may be provided with recesses 27, in which said lower, inwardly directed L-shaped legs 28 of the guide rail 6 can engage when the edge guard 26 is pushed onto the guide rail 6.

If the barrier is to be opened, and the barrier boom 2, mounted on the barrier housing 1, is thus pivoted upward, the connecting pieces 20 on the barrier boom 2 rotate about their pins 21 and the struts 4′ pivot correspondingly, at their angled ends 13, in their respective guide rails 6, 6′ (see FIG. 11) until the barrier, following a pivoting movement of 90°, reaches its fully open position according to FIG. 12, in which both the means for preventing access beneath the barrier and the means for preventing access over the same have been folded together. For the purposes of guiding and stabilizing the entire barrier skirt 3′ during the pivoting movement of the barrier boom 2, all that is required is a connecting rod 7, by means of which that end of the lower guide rail 6 which is directed toward the barrier housing 1 is connected to the barrier housing 1 in an articulated manner via a spacer 8. The connecting rod 7, during the opening closing movements of the barrier, executes a pivoting movement about a point of rotation 9 on the lower guide rail 6 and about a point of rotation 10 on the spacer 8 of the barrier housing 1 (see also FIGS. 10 to 13). The one connecting rod 7 guides the entire barrier skirt 3′, with means for preventing access beneath the barrier and over the same, and prevents a pendulum swinging motion of the barrier skirt 3′ as a whole when the barrier moves quickly; the barrier skirt 3′ is rendered transversely stable (see also FIG. 14). Moreover, the connecting rod 7 prevents the situation where the barrier skirt 3′, with the barrier closed, can be folded manually to allow inadmissible through-passage.

In the case of individual struts 4′ being damaged, these can also be very straightforwardly changed over or replaced in the case of this embodiment of a barrier with a means for preventing access beneath it and over it. As illustrated in FIG. 16, the stub-like protrusions 15 on the end pieces 11 and the rod-like extensions 22 of the connecting pieces 20 can be pushed inward out of the engagement holes 16 on the central pieces 12 of the relevant struts 4′ with the aid of a very straightforward tool, similar to pincers.

Thereafter, the central piece 12 can be pushed to a further extent over the one end piece 11 until it frees the extension 22 of the relevant connecting piece 20. The relevant end piece 11 can then be released from its retaining means in one of the guide rails 6, 6′, the central piece 12 being carried along in the process, and the relevant replacement parts can be assembled. It is also possible here, if necessary, for the connecting piece 20 to be changed over in a straightforward manner.

It is a particular advantage of the barrier skirt 3, 3′ according to the invention that the, as described, very straightforward, tool-free assembly of the barrier skirt can readily take place on site. The individual parts, such as end pieces 11, central pieces 12, guide rails 6, 6′, connecting pieces 20, connecting rod 7, spacer 8, spacer strips 17, can be packed in a very compact manner in the dismantled state for transportation and assembled on site, as described; this considerably reduces the amount of space required for transportation and the transporting costs. Since plastics material is selected for the end pieces 11 and the connecting pieces 20 of the struts 4, 4′ and aluminum is selected for the central pieces 12 of the latter, weight is reduced and the transporting costs are lowered further. It is also the case that the movements of the barrier or of the barrier skirt 3, 3′ have a low noise level, i.e. they are quiet in comparison with known barrier skirts. If required, it is also possible to select stainless steel for the central pieces 12 of the struts 4, 4′; the struts are thus rendered more resistant, for example, to weathering.

### LIST OF DESIGNATIONS

1 Barrier housing

2 Barrier boom

3, 3′ Barrier skirt

4, 4′ Strut

5 Guide groove

6, 6′ Guide rail

7 Connecting rod

8 Spacer

9 Point of rotation (lower) guide rail

10 Point of rotation spacer

11 End pieces with an angled end

12 Central pieces

13 Angled end

14 Convexity

15 Stub-like protrusion

16 Engagement hole

17 Spacer strips

18 Apertures

19 End portions

20 Connecting pieces

21 Pin

22 Rod-like extensions

23 Foot part

24 Connecting stub

25 Side walls of the guide rail

26 Edge guard

27 Recesses

28 L-shaped legs

1. A barrier skirt comprising a number of identically shaped struts which are suspended in a pivotable manner, and at a distance apart from one another, between a barrier boom, which is articulated on a barrier housing and can be pivoted in a vertical plane, and a rail running parallel to the barrier boom, characterized in that that end of the struts (4, 4′) by way of which they are connected in a pivotable manner to a guide rail (6, 6′) running parallel to the barrier boom (2), or to a guide groove (5) on the barrier boom (2), is designed in the form of an angled end (13).

2. The barrier skirt as claimed in claim 1, characterized in that the two ends (13) of the struts (4) are angled in opposite directions, and the one end (13) is connected in a pivotable manner to a guide groove (5) on the barrier boom (2) and the other end (13) is connected in a pivotable manner to a guide rail (6) running at a distance beneath, and parallel to, the barrier boom (2).

3. The barrier skirt as claimed in claim 1, characterized in that the two ends (13) of the struts (4′) are angled, and in that the one angled end (13) of the struts (4′) is connected in a pivotable manner to a guide rail (6) running at a distance beneath, and parallel to, the barrier boom (2) and the other angled end (13) of the struts (4′) is connected in a pivotable manner to a guide rail (6′) running at a distance above, and parallel to, the barrier boom (2), and in that each strut (4′) is connected in a pivotable manner to the barrier boom (2) at a point between, and at a distance from, the two angled ends (13) of the strut.

4. The barrier skirt as claimed in claim 1, characterized in that the one end of the strut (4′) is angled and said angled end (13) is connected in a pivotable manner to a guide rail (6) running at a distance beneath, and parallel to, the barrier boom (2) and the other end of the struts (4′) projects freely upward from the barrier boom (2), and in that each strut (4′) is connected in a pivotable manner to the barrier boom (2) at a point between, and a distance from, the strut ends.

5. The barrier skirt as claimed in claim 1, characterized in that each angled end (13) of the struts (4, 4′) has formed on it a foot part (23), by way of which each strut (4, 4′) is fitted in a pivotable manner in a guide rail (6, 6′) running parallel to the barrier boom (2), or in a guide groove (5) on the barrier boom (2).

6. The barrier skirt as claimed in claim 3, characterized in that the struts (4′) are placed at a distance apart from one another by spacer strips (17) and are retained at a distance which can be selected by the length of the spacer strips (17), said spacer strips being introduced, between the angled ends (13) of the struts (4′), into the guide rails (6, 6′) running at a distance beneath and above, and parallel to, the barrier boom (2).

7. The barrier skirt as claimed in claim 2, characterized in that the struts (4) are placed at a distance apart from one another by spacer strips (17) and are retained at a distance apart from one another which can be selected by the length of the spacer strips (17), said spacer strips being introduced, between the angled ends (13) of the struts (4), into the guide groove (5) on the barrier boom (2) and into the guide rail (6) running at a distance beneath, and parallel to, the barrier boom (2).

8. The barrier skirt as claimed in claim 6, characterized in that the spacer strips (17) are retained in the guide rails (6, 6′) by engagement means and have apertures (18), with which a foot part (23) formed at the angled end (13) of a strut (4, 4′) can be brought into engagement.

9. The barrier skirt as claimed in claim 8, characterized in that the spacer strips (17) are of U-shaped design and are retained in the guide rails (6, 6′) by inwardly curved side walls (25) of the guide rails (6, 6′), and in that the spacer strips (17), in their side walls, have apertures (18), with which the foot part (23) formed at the angled end (13) of a strut (4, 4′) can be brought into engagement.

10. The barrier skirt as claimed in claim 5, characterized in that the foot part (23) at the angled ends (13) of the struts (4, 4′) is formed on transversely and has connecting stubs (24) which are directed transversely to the angled end (13), and counter to one another, and can be brought into engagement with the apertures (18) of a spacer strip (17).

11. The barrier skirt as claimed in claim 1, characterized in that a connecting rod (7) has its one end connected in an articulated manner, at a first point of rotation (9), to that end of a guide rail (6) running at a distance beneath, and parallel to, the barrier boom (2) which is directed towards the barrier housing (1) and has its other end connected in an articulated manner, at a second point of rotation (10), to the barrier housing (1) via a spacer (8).

12. The barrier skirt as claimed in claim 2, characterized in that each strut (4) comprises three individual parts, that is to say two end pieces (11) and a central piece (12), in that the two end pieces (11) are angled at their one end (13) and their other end is of rectilinear design, and in that the end pieces (11), at this rectilinear end, are connected to a respective end of a central piece (12), which is rectilinear throughout.

13. The barrier skirt as claimed in claim 3, characterized in that each strut (4′) comprises five individual parts, that is to say two end pieces (11) with an angled end (13) and a rectilinear end, two central pieces (12), which are rectilinear throughout, and a connecting piece (20), in that each end piece (11) has its rectilinear end, which is directed away from the angled end (13), connected to one end of a central piece (12), which is rectilinear throughout, and in that the other end of each central piece (12), which is rectilinear throughout, is connected to a connecting piece (20), which is articulated on the barrier boom (2).

14. The barrier skirt as claimed in claim 13, characterized in that the connecting piece (20) is arranged laterally on the barrier boom (2) such that it can be pivoted about a pin (21), and it has two oppositely directed extensions (22), to which in each case one end of the central pieces (12) of a strut (4′) can be connected.

15. The barrier skirt as claimed in claim 14, characterized in that the pin (21) about which the connecting piece (20) can be pivoted on the barrier boom (2) is designed such that there is a distance between the barrier boom (2) and the connecting piece (20).

16. The barrier skirt as claimed in claim 12, characterized in that the end pieces (11) are of rod-like design and the central pieces (12) are of tubular design, and the end pieces (11) have their rectilinear end, which is directed away from the angled end (13), connected to a respective end of a central piece (12) by a snap-fit connection (14, 15).

17. The barrier skirt as claimed in claim 12, characterized in that the end pieces (11) are of tubular design and the central pieces (12) are of rod-like design, and the end pieces have their rectilinear end, which is directed away from the angled end (13), connected to a respective end of a central piece (12) by a snap-fit connection (14, 15).

18. The barrier skirt as claimed in claim 14, characterized in that the two end pieces (11) and the oppositely directed extensions (22) of the connecting piece (20) are of rod-like design and the two central pieces (12) of a strut (4′) are of tubular design, and the end pieces (11) have their rectilinear end, which is directed away from the angled end (13), connected to the one end of a central piece (12), and the other end of each central piece (12) is connected to in each case one of the rod-like extensions (22) of a connecting piece (20), by a snap-fit connection (14, 15).

19. The barrier skirt as claimed in claim 14, characterized in that the two end pieces (11) and the oppositely directed extensions (22) of the connecting piece (20) are of tubular design and the two central pieces (12) of a strut (4′) are of rod-like design, and the end pieces (11) have their rectilinear end, which is directed away from the angled end (13), connected to the one end of a central piece (12), and the other end of each central piece (12) is connected to in each case one of the tubular extensions (22) of a connecting piece (20), by a snap-fit connection (14, 15).

20. The barrier skirt as claimed in claim 16, characterized in that, in the case of both end pieces (11), at least one resiliently compliant convexity (14) with an outwardly oriented, stub-like protrusion (15) is provided at the rectilinear end, which is directed away from the angled end and is to be connected to a central piece (12), in that the two tubular ends of each central piece (12) each have at least one lateral engagement hole (16) for the stub-like protrusion (15) of the convexity (14) at the rectilinear end of an end piece (11), and in that the tubular ends of a central piece (12) can each be pushed over that end of an end piece (11) which has the convexity (14) with stub-like protrusion (15) until the stub-like protrusion (15) latches into an engagement hole on the central piece (12).

21. The barrier skirt as claimed in claim 18, characterized in that at least one resiliently compliant convexity (14) with an outwardly oriented, stub-like protrusion (15) is provided at the rectilinear, rod-like end of the two end pieces (11), said end being directed away from the angled end (13), and on the rectilinear, rod-like extensions (22) of the connecting piece (20) of a strut (4′), in that the tubular ends of each central piece (12) each have at least one lateral engagement hole (16) for the stub-like protrusion (15) of one of the convexities (14), and in that the tubular ends of a central piece (12) can each be pushed over that end of the end pieces (11), and of the rod-like extensions (22) of the connecting piece (20), which has the convexity (14) with stub-like protrusion (15) until the stub-like protrusion (15) latches into an engagement hole (16) on the central piece (12).

22. The barrier skirt as claimed in claim 20, characterized in that the diameter of the rectilinear, rod-like end pieces (11) and of the rod-like extensions (22) of the connecting piece (20) at the resiliently compliant convexity (14) in the non-stressed state of said convexity (14) is larger than the open diameter of a central piece (12), and therefore the convexity (14), in the assembled state of a strut (4, 4′), is prestressed and there is a play-free connection between end pieces (11) and central pieces (12) and the connecting piece (20).

23. The barrier skirt as claimed in claim 20, characterized in that the rectilinear, rod-like ends of the end pieces (11) and the rectilinear, rod-like extensions (22) of a connecting piece (20), which are to be connected to the tubular ends of a central piece (12), are designed with two mutually opposite, resiliently compliant, convexities (14), each with a stub-like protrusion (15), and the two tubular ends of the central pieces (12) have two mutually opposite engagement holes (16) for the stub-like protrusions (15) on the end pieces (11) and the rod-like extensions (22) of a connecting piece (20).

24. The barrier skirt as claimed in claim 14, characterized in that a row of connecting pieces (20) is arranged laterally on the barrier boom (2), in that each of the connecting pieces (20) can be pivoted about a pin (21) at a distance from the barrier boom (2) and has oppositely directed extensions (22), to which the central pieces (12) of a strut (4′) can be connected, wherein the connecting pieces (20) on the barrier boom (2) are spaced apart in accordance with the desired distance between the struts (4′).

25. The barrier skirt as claimed in claim 12, characterized in that all the individual parts of the struts (4, 4′)—the end pieces (11), the central pieces (12) and the connecting pieces (20)—consist of a plastics material.

26. The barrier skirt as claimed in claim 12, characterized in that the end pieces (11) and the connecting piece (20) of the struts (4, 4′) consist of a plastics material and the central pieces (12) of the struts (4, 4′) consist of stainless steel.

27. The barrier skirt as claimed in claim 12, characterized in that the end pieces (11) and the connecting pieces (20) of the struts (4, 4′) consist of a plastics material and the central pieces (12) of the struts (4, 4′) consist of aluminum.

28. The barrier skirt as claimed in claim 2, characterized in that at least the guide rail (6) running at a distance beneath, and parallel to, the barrier boom (2), has an edge guard (26) drawn over its entire length.

29. The barrier skirt as claimed in claim 28, characterized in that the edge guard (26) has a bead-like profile on which are provided recesses (27), with which engagement means provided on the guide rail (6) can be brought into engagement.
